(19) United States
(12) Patent Application Publication
(10) Pub. No.: US 2015/0174601 A1
(43) Pub. Date: Jun. 25, 2015

(54) SURFACE TREATMENT PROCESS AND COATING MECHANISM OF ROLLED TAPE

(71) Applicant: TOP LONG INDUSTRIAL CO., LTD., New Taipei City (TW)

(72) Inventor: PING-LIN LIN, New Taipei City (TW)

(73) Assignee: TOP LONG INDUSTRIAL CO., LTD., New Taipei City (TW)

(21) Appl. No.: 14/135,539

(22) Filed: Dec. 19, 2013

(51) Int. Cl. B05C 1/08; B05D 1/38; B05D 1/40; B05C 9/12; B05D 3/04; B05D 3/12; B05C 9/14; B05D 1/28; B05D 3/02

(52) U.S. Cl. CPC B05C 1/0817; B05D 1/28; B05D 1/38; B05D 1/40; B05D 3/0254; B05D 3/04; B05D 3/12; B05C 1/0813; B05C 1/0834; B05C 1/0839; B05C 9/14; B05C 9/12

(57) ABSTRACT

The present invention relates to a surface treatment process and a coating mechanism of a rolled tape, in which a feeding module conveys a rolled tape so that the rolled tape is conveyed by the feeding module to first contact a surfactant received in a surfactant tank and then moved to a drying device to have the surfactant dried, and then moved to one side of a coating assembly to contact therewith, where the coating assembly receives a covering material contained in a receiving tank to attach thereto and control the thickness thereof for subsequently applying and coating the covering material to the rolled tape. The rolled tape, after being coated, is moved towards a baking device to have the covering material dried and is then collected by the feeding module.

### TECHNICAL FIELD OF THE INVENTION

The present invention provides a surface treatment process and a coating mechanism of a rolled tape, and more particularly to a surface treatment process and a coating mechanism that can reduce cost by eliminating the use of molds, provides a product having a reduced thickness that uniform, precise, and adjustable, and allows for simultaneous manufacture of multiple tapes.

### DESCRIPTION OF THE PRIOR ART

The conventional way of covering a measure tape with nylon resin is as follows:

(A) placing a strip of a measure tape on a feeding roll carrier;

(B) allowing the strip of the measure tape to move into a pre-heating chamber for baking and temperature rising;

(C) using a heater to heat the strip of the measure tape;

(D) guiding the strip of the measure tape into a mold;

(E) using an extrusion machine to inject nylon resin into the mold to cover the strip of the measure tape;

(F) using a stamping mechanism to stamp and fix shape of the strip of the measure tape;

(G) moving the strip of the measure tape into a cooling water tank for cooling and shape fixing; and

(H) winding the strip of the measure tape around the roll carrier.

During the manufacture, a coating mold must be prepared in advance so that the cost is increased and it is not possible to alter the thickness of the nylon resin. Further, the strip of the measure tape may shift frontwards in the coating mold and may induce displacement upward/downward and/or leftward/rightward, leading to non-uniform distribution of the nylon resin thickness coated on the strip of the measure tape. Further, it requires the thickness of the nylon resin to be increased in order to prevent un-covering of the strip of the measure tape with the nylon resin. However, this also leads to re-molding and re-manufacturing of the measure tape case that is used to accommodate the strip of the measure tape therein.

### SUMMARY OF THE INVENTION

The primary object of the present invention is to ensure uniform thickness of coating and enable adjustment of thickness according to needs.

Another object of the present invention is to enable simultaneous coating of a plurality of rolled tapes.

A further object of the present invention is to enable direct coating so as to eliminate the cost of molds.

To achieve the above objects, the present invention comprises a feeding module for conveying a rolled tape and, arranged within the feeding module, a surfactant tank that receives therein a surfactant, a drying device, a receiving tank that stores therein a covering material, a coating assembly, and a baking device. In the operation of the present invention, the feeding module drives the rolled tape to move in such a way that the rolled tape is moved by the feeding module to contact the surfactant contained in the surfactant tank and then moved to the drying device to have the surfactant on the rolled tape dried. The rolled tape, after being dried, is further moved to one side of the coating assembly, where the coating assembly receives, in advance, the covering material of the receiving tank to attached thereto and a spacing distance of the coating assembly is adjusted to control the thickness of attachment and the thickness-controlled covering material is coated to at least one side of the rolled tape to contact the surfactant. The rolled tape, after being coated with the covering material, is moved forward into the baking device to have the covering material on the rolled tape dried. After drying, the feeding module collects and organizes the rolled tape to form a coated rolled tape that has a uniform overall thickness of coating and a reduced final product thickness. With such a technique, the problems that the molding process of the conventional nylon resin coated measure tape has a high manufacturing cost, non-uniform distribution of thickness, a relatively thick final product that makes it necessary to re-manufacture a tape case can be overcome and practical improvements of eliminating the use of molds so as to reduce the cost, providing a final product having a reduced thickness that is uniform and precise, and allowing for simultaneous manufacturing of multiple tapes can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the implementation of the present invention.

FIG. 2 is a schematic view illustrating a coating operation of the present invention.

FIG. 3 is a schematic view illustrating a treatment process of the present invention.

FIG. 4 is a schematic view the implementation of manufacturing of multiple tapes according to the present invention.

FIG. 5 is a schematic view illustrating feeding of multiple tapes according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

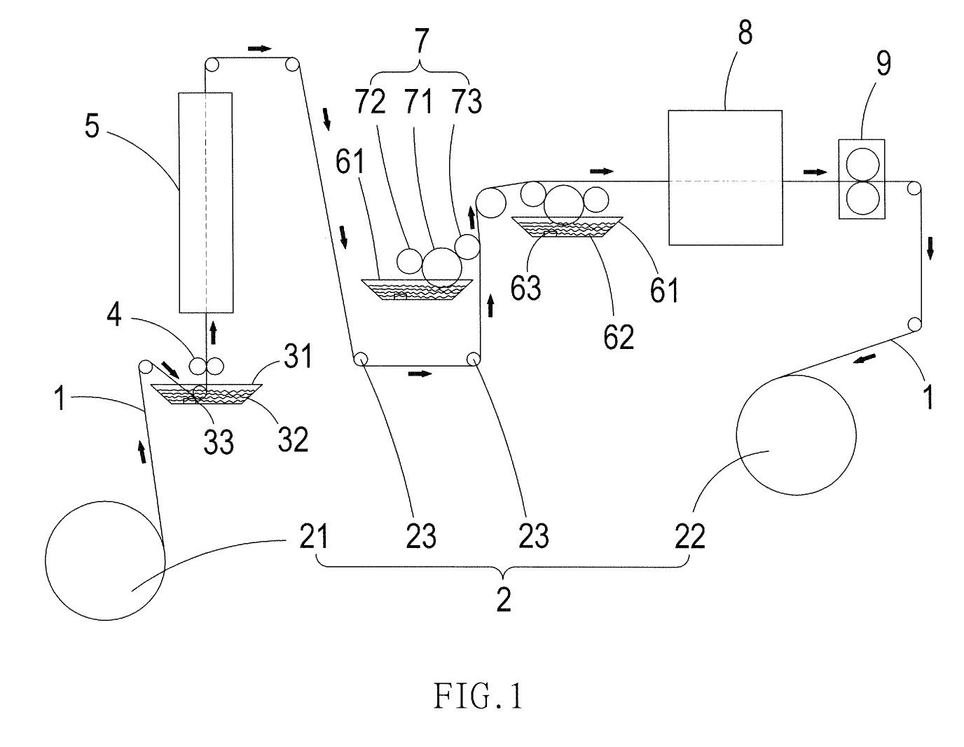

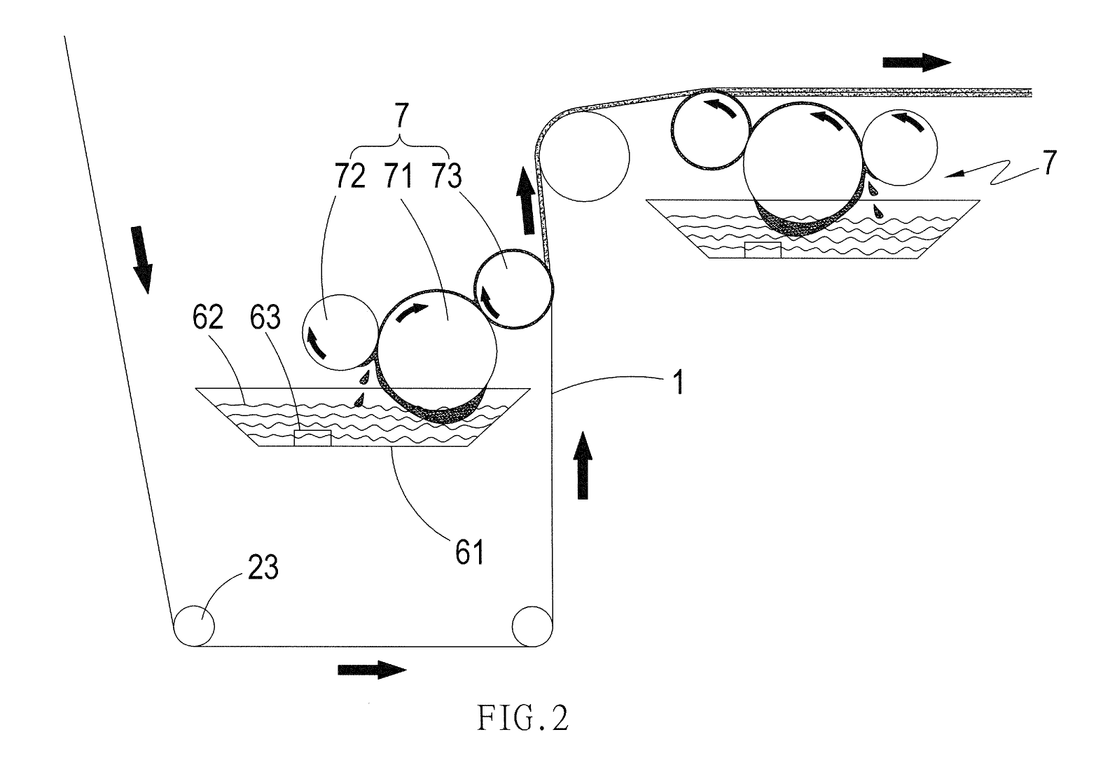

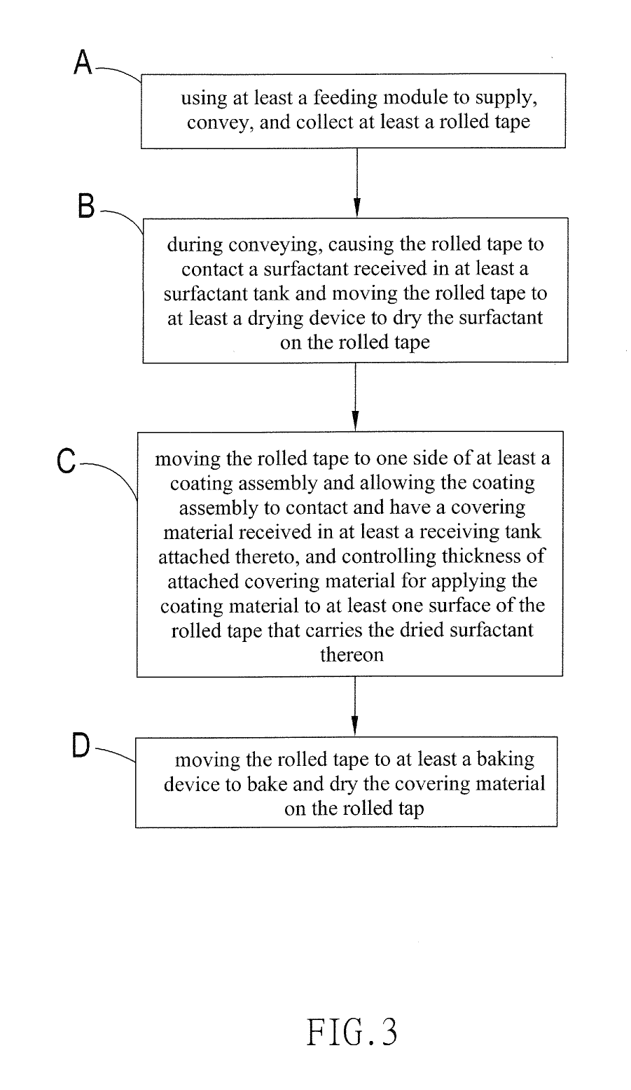

Referring to FIGS. 1-5, the drawings clearly show that the present invention comprises at least a feeding module 2 and, arranged between components of the feeding module 2, at least a surfactant tank 31 that receives therein a surfactant 32, at least an adequacy device 4, at least a drying device 5, at least a receiving tank 61 that receives therein a covering material 62, at least a coating assembly 7, at least a baking device 8, and at least a pressurizing device 9. The feeding module 2 supplies and conveys at least one rolled tape 1. The feeding module 2 comprises at least a supply roller 21, at least a collection roller 22, and a plurality of transmission rollers 23. The supply roller 21 supplies the rolled tape 1 to the surfactant tank 31. The plurality of transmission rollers 23 is arranged between the supply roller 21 and the collection roller 22 to convey the rolled tape 1 sequentially to the surfactant tank 31, the adequacy device 4, the drying device 5, the coating assembly 7, the baking device 8, and the pressurizing device 9, so as to allow the collection roller 22 to retrieve and collect the rolled tape 1 to which the covering material 62 is applied and dried. The rolled tape 1 can be a curved measure tape which has marking ink printed thereon. The coating assembly 7 comprises at least an attachment roller 71 that is set in contact the covering material 62, at least a control roller 72 that controls the thickness of the covering material 62 attached to the attachment roller 71, and at least a transfer-coating roller 73 that applies and coats the covering material 62 from the attachment roller 71 to the rolled tape 1. The receiving tank 61 comprises a covering material stabilization device 63 arranged therein for heating the covering material 62 so as to maintain the temperature of the covering material 62, ensure the cleanliness of the covering material 62, replenish the covering material 62, or control the solution concentration of the covering material 62. Further, the covering material 62 can be liquid nylon. Further, the surfactant tank 31 comprises a surfactant stabilization device 33 arranged therein to maintain cleanliness of the surfactant 32, replenish the surfactant 32, or control the concentration of the surfactant 32.

The manufacturing process of the present invention is as follow:

(A) using at least a feeding module to supply, convey, and collect at least a rolled tape;

(B) during conveying, causing the rolled tape to contact a surfactant received in at least a surfactant tank and moving the rolled tape to at least a drying device to dry the surfactant on the rolled tape;

(C) moving the rolled tape to one side of at least a coating assembly and allowing the coating assembly to contact and have a covering material received in at least a receiving tank attached thereto, and controlling thickness of attached covering material for applying the coating material to at least one surface of the rolled tape that carries the dried surfactant thereon; and

(D) moving the rolled tape to at least a baking device to bake and dry the covering material on the rolled tape.

In step (B), the rolled tape 1, after contacting the surfactant 32, is caused to first contact an adequacy device 4 arranged between the surfactant tank 31 and the drying device 5 to remove an excess of the surfactant 32 for enhancing the subsequent operation of smoothened coating and then moved into the drying device 5 in order to maintain the stability of the surfactant 32.

In step (C), the attachment roller 71, the control roller 72, and the transfer-coating roller 73 of the coating assembly 7 each have an individual power source to drive them to rotate. In the drawings, an illustration including two sets of coating assembly 7 arranged at opposite sides of the rolled tape to each carry out coating on the rolled tape is given for explanation. In the operation of the coating assembly 7, the attachment roller 71 is rotate to draw up and carry the covering material 62 and is kept at a predetermined distance from the control roller 72 in order to scrape, partly, and control the thickness of the covering material 62 attached to and carried by the attachment roller 71. Further, the distance between the attachment roller 71 and the control roller 72 can be changed to meet the needs for different thickness. The transfer-coating roller 73 levels the rolled tape 1 to form a temporary flat surface and then, the transfer-coating roller 73 applies and coats the thickness-controlled covering material 62 attached to the attachment roller 71 to the rolled tape 1 to combine with the surfactant 32 to make the application and coating more uniform and production easier. As such, a final product of which an overall thickness is reduced and the thickness of the coated covering material 62 is uniform and accurate can be obtained. Since the thickness of the final product is reduced, the final product of a coated measure tape and a measure tape that is not coated with the covering material 62 can share the same tape case so a s to lower down the manufacturing cost.

In step (D), the rolled tape 1 having the covering material 62 coated thereon and dried is conveyed to a pressurizing device 9 to allow the pressurizing device 9 to process the covering material 62 for generating a patterned or matted surface of the covering material 62 and for making the surface more smooth and thickness uniform and, afterwards, the rolled tape 1 is collected by the collection roller 22.

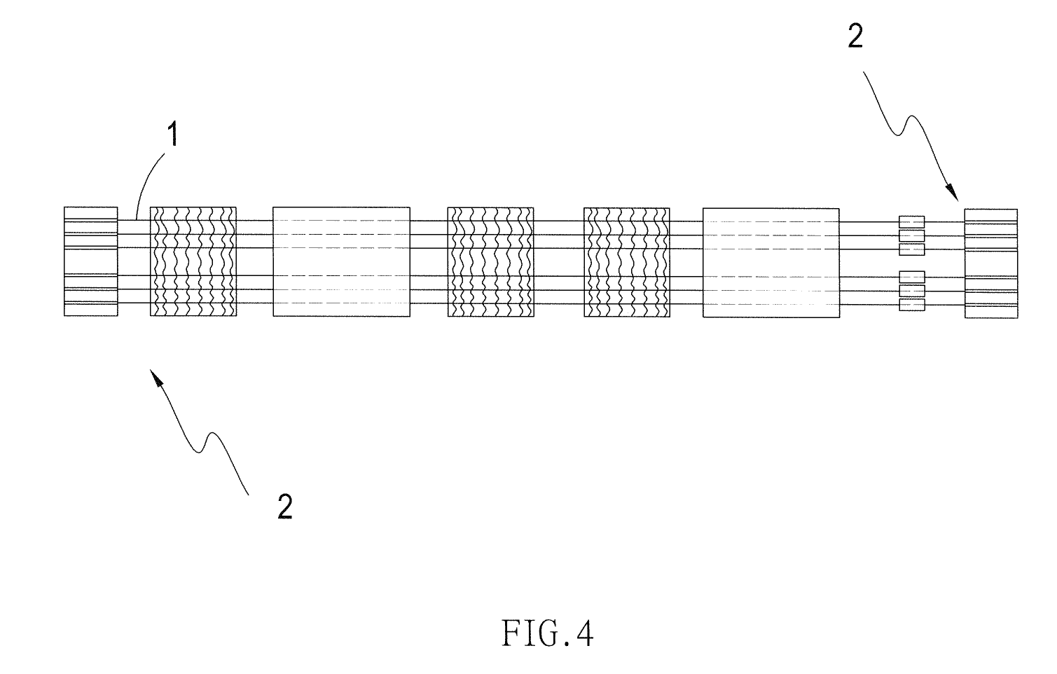

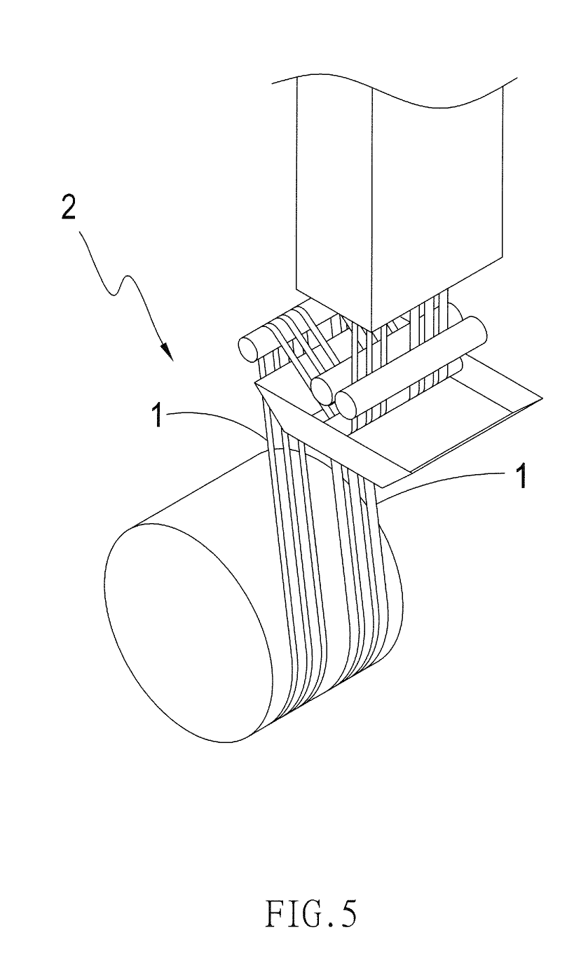

Further, as shown in FIGS. 4 and 5, the present invention can simultaneously arrange a plurality of rolled tapes 1 on the feeding module 2 is a spaced manner and the rolled tapes 1 can be of different widths so that manufacturing of a plurality of tapes can be done simultaneously for enhancing the operation performance.

Thus, the present invention provides a surface treatment process and a coating mechanism of a rolled tape, of which the technical features that are adopted to improve the prior art techniques are as follows:

(1) A coating assembly 7 is used to allow the present invention to achieve a practical improvement of eliminating the use of molds and reducing cost.

(2) A coating assembly 7 and an adequacy device 4 are used to allow the present invention to achieve a practical improvement of proving a final product that has a reduced thickness so as to lower down cost and ensure uniform and precise thickness.

(3) A combination of a coating assembly 7 and a feeding module 2 is used to allow the present invention to achieve a practical improvement of simultaneous manufacturing of multiple tapes.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A surface coating mechanism of a rolled tape, comprising:
at least a feeding module, wherein the feeding module conveys and retrieves and collects at least a rolled tape;
at least a surfactant tank that receives therein a surfactant, the surfactant tank being arranged within the feeding module, the rolled tape being set in contact with the surfactant;
at least a drying device, wherein the drying device is arranged within the feeding module for drying the surfactant on the rolled tape;
at least a receiving tank that receives therein a covering material, the receiving tank being arranged within the feeding module;
at least a coating assembly, wherein the coating assembly receives the covering material to attach thereto, control thickness of attachment, and applies and coats the covering material to at least one side of the rolled tape that comprises the dried surfactant thereon; and
at least a baking device, wherein the baking device is arranged within the feeding module for drying the covering material on the rolled tape.

2. The surface coating mechanism of the rolled tape according to claim 1, wherein at least a pressurizing device is arranged within the feeding module to process the dried covering material to provide the covering material with a patterned or matted surface.

3. The surface coating mechanism of the rolled tape according to claim 1, wherein the covering material is a liquid nylon and the receiving tank comprises a covering material stabilization device arranged therein, the surfactant tank comprising a surfactant stabilization device arranged therein, at least an adequacy device being arranged between the surfactant tank and the drying device to remove an excess of the covering material on the rolled tape.

4. The surface coating mechanism of the rolled tape according to claim 1, wherein the coating assembly comprises at least an attachment roller that is set in contact the covering material, at least a control roller that controls thickness of the covering material attached to the attachment roller, and at least a transfer-coating roller that applies and coats the covering material from the attachment roller to the rolled tape.

5. The surface coating mechanism of the rolled tape according to claim 1, wherein the feeding module comprises at least a supply roller, at least a collection roller, and a plurality of transmission rollers the supply roller supplying the rolled tape to the surfactant tank, the collection roller retrieving and collecting the rolled tape to which the covering material is applied and dried.

6. A surface treatment process of a rolled tape, comprising:
(A) using at least a feeding module to supply, convey, and collect at least a rolled tape;
(B) during conveying, causing the rolled tape to contact a surfactant received in at least a surfactant tank and moving the rolled tape to at least a drying device to dry the surfactant on the rolled tape;
(C) moving the rolled tape to one side of at least a coating assembly and allowing the coating assembly to contact and have a covering material received in at least a receiving tank attached thereto, and controlling thickness of attached covering material for applying the coating material to at least one surface of the rolled tape that carries the dried surfactant thereon; and
(D) moving the rolled tape to at least a baking device to bake and dry the covering material on the rolled tap.

7. The surface treatment process of the rolled tape according to claim 6, wherein at least a pressurizing device is arranged within the feeding module to process the dried covering material to provide the covering material with a patterned or matted surface.

8. The surface treatment process of the rolled tape according to claim 6, wherein the covering material is a liquid nylon and the receiving tank comprises a covering material stabilization device arranged therein, the surfactant tank comprising a surfactant stabilization device arranged therein, at least an adequacy device being arranged between the surfactant tank and the drying device to remove an excess of the covering material on the rolled tape.

9. The surface treatment process of the rolled tape according to claim 6, wherein the coating assembly comprises at least an attachment roller that is set in contact the covering material, at least a control roller that controls thickness of the covering material attached to the attachment roller, and at least a transfer-coating roller that applies and coats the covering material from the attachment roller to the rolled tape.

10. The surface treatment process of the rolled tape according to claim 6, wherein the feeding module comprises at least a supply roller, at least a collection roller, and a plurality of transmission rollers the supply roller supplying the rolled tape to the surfactant tank, the collection roller retrieving and collecting the rolled tape to which the covering material is applied and dried.
